(19) United States
(12) Patent Application Publication
(10) Pub. No.: US 2026/0243917 A1
(43) Pub. Date: Aug. 20, 2026

(54) SYSTEM AND METHOD HAVING MACHINE LEARNING-ASSISTED INVERSION OF BOREHOLE MEASUREMENTS

(71) Applicant: Schlumberger Technology Corporation, Sugar Land, TX (US)

(72) Inventors: Tianqi Deng, Sugar Land, TX (US); Gong Li Wang, Sugar Land, TX (US); Xiaoyan Zhong, Sugar Land, TX (US); Keli Sun, Sugar Land, TX (US); Kent Harms, Sugar Land, TX (US)

(21) Appl. No.: 19/057,308

(22) Filed: Feb. 19, 2025

(51) Int. Cl. G01V 3/38; G01V 3/30; G01V 3/34

(52) U.S. Cl. CPC G01V 3/38; G01V 3/30; G01V 3/34

(57) ABSTRACT

A method includes receiving measurement data from a downhole tool in a borehole in a geological formation. The method further includes performing a borehole correction inversion of the measurement data assisted by a machine learning model to obtain one or more properties, wherein performing the borehole correction inversion includes obtaining initial guesses for borehole and formation parameters of the borehole correction inversion at least partially via the machine learning model. The method further includes adjusting one or more operating parameters based on the one or more properties or the borehole correction inversion of the measurement data, wherein the one or more operating parameters include drilling parameters, post-drilling parameters, or a combination thereof.

### BACKGROUND

This disclosure relates generally to downhole measurements in a wellbore and, more particularly, inversion of electromagnetic (EM) measurements.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Producing hydrocarbons from a wellbore drilled into a geological region is a remarkably complex endeavor. In many cases, decisions involved in hydrocarbon exploration and production may be informed by measurements from downhole well-logging tools that are conveyed deep into the wellbore. The measurements may be used to infer properties or characteristics of the geological region surrounding the wellbore.

Well logging tools, such as downhole tools, are utilized to measure borehole and formation properties for formation evaluation, reservoir mapping and geosteering, etc. These logging tools can include, for example, EM logging tools. The logging tools are typically utilized in conjunction with logging-while-drilling (LWD) operations or mapping-while-drilling operations in which formation evaluation measurements (e.g., resistivity, porosity, etc.) are taken during drilling operations. These measurements can be useful in providing, for example, bed boundary detection as well as delineation of reservoir boundaries and fluid contacts in a formation. However, it is presently recognized that such measurements may be hard to directly quantitatively interpret due to the effects of borehole, shoulder beds, formation geometries in wells, and other environmental effects on the EM tool responses.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In certain embodiments, a method includes receiving measurement data from a downhole tool in a borehole in a geological formation. The method further includes performing a borehole correction inversion of the measurement data assisted by a machine learning model to obtain one or more properties. Performing the borehole correction inversion includes building a borehole table for a plurality of muds using an expansion for a tool response in an azimuthal direction of the machine learning model. Performing the borehole correction inversion further includes obtaining initial guesses for borehole and formation parameters of the borehole correction inversion at least partially via the machine learning model. Performing the borehole correction inversion uses at least partially the initial guesses in the plurality of muds to determine the borehole and formation parameters. The method further includes adjusting one or more operating parameters based on the one or more properties or the borehole correction inversion of the measurement data, wherein the one or more operating parameters include drilling parameters, post-drilling parameters, or a combination thereof.

In certain embodiments, a system includes a processor and a memory including instructions executable by the processor, wherein the instructions are configured to perform operations including receiving measurement data from a downhole tool in a borehole in a geological formation. The operations further include performing a borehole correction inversion of the measurement data assisted by a machine learning model to obtain one or more properties, wherein performing the borehole correction inversion includes obtaining initial guesses for borehole and formation parameters of the borehole correction inversion at least partially via the machine learning model.

In certain embodiments, tangible and non-transitory machine readable medium including instructions configured to perform operations including receiving measurement data from a downhole tool in a borehole in a geological formation. The operations further include performing a borehole correction inversion of the measurement data assisted by a machine learning model to obtain one or more properties, wherein performing the borehole correction inversion includes obtaining initial guesses for borehole and formation parameters of the borehole correction inversion at least partially via the machine learning model.

It is appreciated that implementations in accordance with the present disclosure can include any combination of the aspects and features described herein. That is, implementations in accordance with the present disclosure are not limited to the combinations of aspects and features specifically described herein, but also include any other appropriate combinations of the aspects and features provided.

### BRIEF DESCRIPTION OF THE DRAWINGS

These and other features, aspects, and advantages of the presently disclosed embodiments will become better understood when the following detailed description is read with reference to the accompanying drawings in which like characters represent like parts throughout the drawings, wherein:

FIG. 1 depicts an example wellsite system for measuring borehole data using various downhole tools and surface tools, in accordance with embodiments of the present disclosure;

FIG. 2 depicts a well control system configured to control the wellsite system of FIG. 1, in accordance with embodiments of the present disclosure;

FIG. 3 depicts an example of an electromagnetic (EM) logging tool as the logging tool of FIG. 1, in accordance with embodiments of the present disclosure;

FIG. 4 depicts a set of plots illustrating modeling techniques employed to simulate the wellsite system of FIG. 1 and, particularly, the borehole, the EM tool, and the associated formation for determining certain borehole and formation parameters, in accordance with embodiments of the present disclosure;

FIG. 5 is a flowchart of an embodiment of a method of computing simulated measurement channels using a surrogate model;

FIG. 6 is a flowchart of an embodiment of a method to predict initial guesses of certain borehole and formation parameters; and

FIG. 7 is a flowchart of an embodiment of a method of performing operations associated with the wellsite system of FIG. 1 based on inverted borehole and formation parameters and/or borehole-corrected measurements.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

In the following description, for the purposes of explanation, numerous specific details are set forth in order to provide a thorough understanding of embodiments of the present disclosure. It will be apparent, however, to one skilled in the art that embodiments of the present disclosure may be practiced without some of these specific details.

Downhole tools, such as electromagnetic (EM) logging tools, provide downhole measurements that may aid decision-making during wellsite operations. For example, by injecting electrical current into a mud or fluid-filled borehole and measuring the resulting potential difference (i.e., voltage), EM logging tools may detect variations in the electrical resistivity of borehole-intersected formations surrounding the tools to characterize properties of the downhole environment, such as density, porosity, resistivity, lithology, fluid content, saturation, and so forth.

Interpretation workflows of the downhole EM tool measurements usually involve applying various inversion methods on the downhole EM tool responses. However, it is widely recognized that downhole EM measurements may be hard to directly quantitatively interpret due to effects of borehole and other environmental effects on the EM tool responses. Inversion workflows that merely ignore the borehole effects often produce inaccurate interpretation results. Thus, various borehole correction workflows may be integrated into the inversion workflow, in an attempt to estimate certain borehole and formation parameters and, subsequently, correct EM measurements for borehole effects. However, these borehole correction workflows are often associated with high computational costs, making them challenging to run in practice. An inversion workflow with reduced computational cost is desirable to obtain faster (e.g., real-time) and more accurate measurements of desired properties of the downhole environment.

The present disclosure is directed to an improved, machine learning-assisted inversion workflow that is configured to reduce the computational costs of borehole correction. Specifically, the present disclosure includes at least the following three improvements to the existing inversion workflow. First, the presently disclosed inversion workflow uses machine learning models to generate initial guesses for the inversion. Second, the presently disclosed inversion workflow uses azimuthal equations to calculate certain borehole and formation parameters (e.g., dip and eccentric azimuthal angles) directly from measurement channels. Third, the presently disclosed inversion workflow uses a pre-computed table and azimuthal expansion. By implementing these three improvements, the present disclosure enables a faster (e.g., real-time) and more stable inversion workflow. Thus, the machine learning-assisted inversion workflow may substantially increase the efficiency of control systems using the machine learning-assisted inversion workflow to obtain real-time information about the geological formation, thereby enabling real-time adjustments to a drilling system (e.g., adjustments in a direction of drilling, a rotational speed of a drill bit, a flow rate of drilling mud, a weight on bit, a torque on bit, a mud weight, a mud viscosity, a rate of penetration, and the like). Various aspects of the present disclosure are discussed in further detail below.

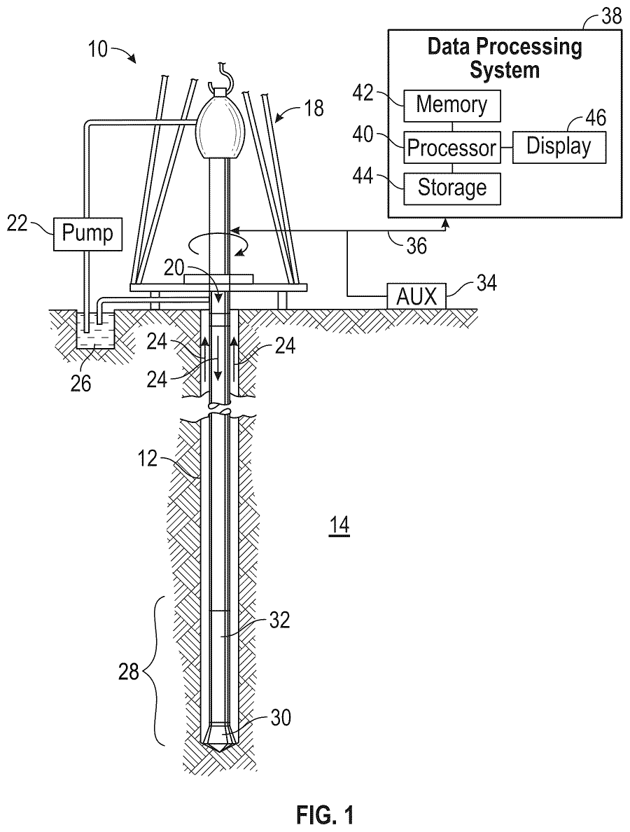

With the foregoing in mind, FIG. 1 illustrates a drilling system 10 that may employ the systems and methods of this disclosure. The drilling system 10 may be used to drill a borehole 12 into a geological region 14. In the drilling system 10, a drilling rig 18 may rotate a drill string 20 within the borehole 12. As the drill string 20 is rotated, a drilling fluid pump 22 may be used to pump drilling fluid, which may be referred to as “mud” or “drilling mud,” downward through the center of the drill string 20, and back up around the drill string 20, as shown by reference arrows 24. At the surface, return drilling fluid may be filtered and conveyed back to a mud pit 26 for reuse. The drilling fluid may travel down to the bottom of the drill string 20 known as the bottom-hole assembly (BHA) 28. The drilling fluid may be used to rotate, cool, and/or lubricate a drill bit 30 that may be a part of the BHA 28. The fluid may exit the drill string 20 through the drill bit 30 and carry drill cuttings away from the bottom of the borehole 12 back to the surface.

The BHA 28 may include the drill bit 30, a rotary steerable system (RSS), and various downhole tools, such as one or more logging tools 32. The RSS may include a plurality of radially adjustable pads configured to move radially inward and outward relative to a central axis of the BHA, thereby enabling geosteering (e.g., steering of the drill bit 30) in a desired direction based on various measurements from the logging tools 32. For example, if measurements from the logging tools 32 are acquired and processed in real-time (e.g., real-time inversion using machine learning-assisted inversion), then the RSS may be controlled in real-time to change a direction of the drilling toward any areas of interest in a geological formation. The BHA 28 may thus convey the one or more logging tools 32 through the geological region 14 via the borehole 12, and the presently disclosed machine learning-assisted inversion techniques are used to perform a more efficient inversion of the measurements. As described in greater detail herein, the one or more logging tools 32 may be any suitable downhole tool that emits electromagnetic waves within the borehole 12 (e.g., a downhole environment). The downhole tools, which may include the one or more logging tools 32, may collect a variety of information relating to the geological region 14 and the state of drilling in the borehole 12. For instance, the downhole tools may be logging-while drilling (LWD) tools that measure physical properties of the geological region 14, such as density, porosity, permeability, resistivity, lithology, fluid content, saturation, and so forth. Likewise, the downhole tools may be measurement-while-drilling (MWD) tools that measures certain drilling parameters, such as the temperature, pressure, orientation of the drill bit 30, mapping-while-drilling tools, and so forth.

The one or more logging tools 32 may receive energy from an electrical energy device or an electrical energy storage device, such as an auxiliary power source 34 or another electrical energy source to power the tool. In some embodiments, the one or more logging tools 32 may include a power source within the one or more logging tools 32, such as a battery system or a capacitor, to store sufficient electrical energy to emit and/or receive electromagnetic waves.

Communications 36, such as control signals, may be transmitted from a data processing system 38 to the one or more logging tools 32, and communications 36, such as data signals related to the results/measurements of the one or more logging tools 32, may be returned to the data processing system 38 from the one or more logging tools 32. The data processing system 38 also may be described as a control system, which includes a controller 39. In certain embodiments, the data processing system 38 may include a downhole processing system or controller, a surface processing system or controller, or both to facilitate communications with and control operations of various downhole and surface components of the drilling system 10. The data processing system 38 may be any electronic data processing system that can be used to carry out the systems and methods of this disclosure. For example, the controller 39 of the data processing system 38 may include one or more processors 40, which may execute instructions stored in memory 42 and/or storage 44. The memory 42 and/or the storage 44 of the data processing system 38 may be any suitable article of manufacture that can store the instructions. In certain embodiments, the one or more processors 40 may include a microprocessor, a microcontroller, a processor module or subsystem, a programmable integrated circuit, a programmable gate array, a digital signal processor (DSP), or another control or computing device. In certain embodiments, the one or more processors 40 may include machine learning and/or artificial intelligence (AI) based processors.

In certain embodiments, the memory 42 and storage 44 are implemented as one or more non-transitory computer-readable or machine-readable storage media. In certain embodiments, the memory 42 may include one or more different forms of memory, including semiconductor memory devices such as dynamic or static random access memories (DRAMs or SRAMs), erasable and programmable read-only memories (EPROMs), electrically erasable and programmable read-only memories (EEPROMs) and flash memories. The storage 44 may include solid state drives, magnetic disks such as fixed, floppy and removable disks; other magnetic media including tape; optical media such as compact disks (CDs) or digital video disks (DVDs); or other types of storage devices. Note that the computer-executable instructions and associated data of the analysis module(s) may be provided on one computer-readable or machine-readable storage medium of the memory 42 or the storage 44, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the storage 44 may be located either in the machine running the machine-readable instructions or may be located at a remote site from which machine-readable instructions may be downloaded over a network for execution. In certain embodiments, the controller 39 may include instructions stored on the memory 42 and/or storage 44 and executable by the processor 40 to perform various aspects of inversion of measurements (e.g., machine learning-assisted inversion) of measurements acquired by the logging tool 32, and control one or more operational parameters (e.g., direction of drilling via RSS, rotational speed of drill bit, flow rate of drilling mud, weight on bit, torque on bit, mud weight, mud viscosity, rate of penetration, etc.) of the drilling system 10.

As illustrated, the data processing system 38 may optionally also include a display 46, which may be any suitable electronic display that may display images generated by the processor 40. The data processing system 38 may be a local component of the drilling system 10 (i.e., at the surface), within the one or more logging tools 32 (i.e., downhole), a device located proximate to the drilling operation, and/or a remote data processing device located away from the drilling system 10 to process downhole measurements in real time or sometime after the data has been collected. In some embodiments, the data processing system 38 may be a portable computing device (e.g., tablet, smart phone, or laptop) or a server remote from the drilling system 10. In some embodiments, the one or more logging tools 32 may store and process collected data in the BHA 28 or send the data to the surface for processing via communications 36 described above, including any suitable telemetry (e.g., electrical signals pulsed through the geological region 14 or mud pulse telemetry using the drilling fluid).

It should be noted that, although the discussion above relates to a drilling system, other downhole equipment or systems may employ the systems and methods of this disclosure. For example, a downhole tool with an electromagnetic tool conveyed by slickline, coiled tubing, wireline, or other delivery systems, may utilize the disclosed systems and methods.

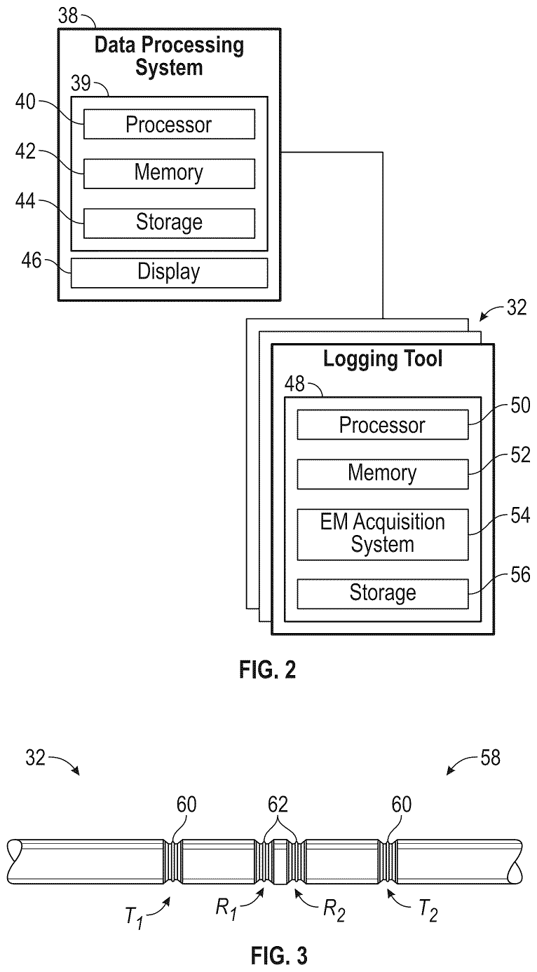

Operation of the drilling system 10 may be controlled by a processor of the data processing system 38. For example, FIG. 2 illustrates a block diagram of the data processing system 38 that is communicatively coupled to the one or more logging tools 32. In the illustrated embodiment, a logging tool 32 includes a controller 48 having a processor 50, memory 52, an electromagnetic (EM) acquisition system 54, and storage 56. The controller 48 may include instructions stored on the memory 52 and/or storage 56 and executable by the processor 50 to perform various aspects of data acquisition, inversion of measurements (e.g., machine learning-assisted inversion), and control one or more operational parameters (e.g., direction of drilling via RSS, rotational speed of drill bit, flow rate of drilling mud, weight on bit, torque on bit, mud weight, mud viscosity, rate of penetration, etc.) of the drilling system 10. In some embodiments, the processor 50 may be ASIC (application specific integrated circuit), field programmable gate array (FPGA), a micro control unit (MCU), a digital signal processor (DSP), and the like. In general, the drilling system 10 communicates with the data processing system 38 via a data cable, telemeter or other suitable techniques. For example, the drilling system 10 may communicate EM measurements obtained by an EM sensor (or meter) as part of the EM acquisition system 54. In turn, a processor of the surface control system may determine certain parameters (e.g., porosity, water saturation, permeability, velocities, resistivity, lithology, density, and so forth) based on the EM measurements. In such embodiments, the EM acquisition system 54 may include an emission source (e.g., an antenna) to acquire, obtain, or otherwise measure EM measurements.

In certain embodiments, the data processing system 38 may include one or more analysis modules (e.g., a program of computer-executable instructions and associated data) that may be configured to perform various functions of the embodiments described herein. In certain embodiments, to perform these various functions, the one or more analysis modules may be executed on one or more processors 40 of the processing system 38, which may be connected to memory 42 and storage 44 in which the one or more analysis modules may be stored.

In certain embodiments, the computer-executable instructions of the one or more analysis modules, when executed by the one or more processors 40, may cause the one or more processors 40 to generate one or more models (e.g., forward model, inverse model, mechanical model, and so forth). Such models may be used by the processing system 38 to predict values of operational parameters that may or may not be measured (e.g., using gauges, sensors, and so forth) during well operations. The machine learning-assisted inversion techniques discussed in further detail below may be stored and executed on the data processing system 38, the logging tool 32, or a combination thereof.

FIG. 3 illustrates an example of an electromagnetic (EM) logging tool 58 that can be utilized as one of the one or more logging tools 32. The EM logging tool 58 (e.g., EM tool 58) includes a plurality of transmitter-receiver (T-R) pairs of transmitters 60 and receivers 62. As illustrated, the transmitter-receiver (T-R) pairs include coils (e.g., co-axial coils) as transmitters 60 and receivers 62 disposed along the EM tool 58. One or both of the receivers 62 can include tilted and/or transverse and/or axial coils (e.g., antenna). This allows for mapping-while-drilling or LWD services that provide rapid and high delineation of reservoir layers and formation evaluation while drilling.

Referring generally to FIGS. 1-3, responses obtained through the downhole EM tool 58 may be affected by borehole fluid (e.g., drilling mud), surrounding rock formation, and other geological structures (e.g., nearby layers and boundaries). That is, the measurement channels acquired through the downhole EM tool 58 may include the responses from the borehole 12, surrounding rock formation, and/or other geological structures. For example, the measurement channels (d̅ₜ) may be represented by Equation (1) below:

$${\overline{d}}_{t} = {\overline{d}}_{bh} + {\overline{d}}_{f} + {\overline{d}}_{o} , \qquad ( 1 )$$

where d̅_{bh} is the response due to the presence of a borehole, d̅_{f} is the response that would be measured in the same formation without the borehole, and d̅ₒ is an inclusive term for any other responses, e.g. noise. In practice, d̅ₒ may be negligible, the measurement channels may be simplified to Equation (2) below:

$${\overline{d}}_{t} = {\overline{d}}_{f} + {\overline{d}}_{bh} . \qquad ( 2 )$$

Thus, by assessing and removing the borehole effect (as manifested as the response from the borehole 12), the response from the formation may be isolated from the measurement channels obtained from the EM tool 58, enabling a more accurate assessment of the physical properties of formation during drilling operations. It should be noted that the borehole effect on the measurement channels may broadly include effects of the borehole 12, the tool body 58, and their interactions with the formation, and such combined effect may be modeled by solving for the magnetic field near the EM tool 58 in a homogeneous anisotropic formation.

Accordingly, simulation models of the drilling system 10 may be built to assess the borehole effect and, subsequently, correct for the borehole effect in the measurement channels. Specifically, certain borehole and formation parameters may be estimated by solving a nonlinear least-square problem to find the borehole and formation parameters that may cause a forward simulation model to produce simulated measurement channels that match the actual measurement channels obtained by the EM tool 58. For example, the nonlinear least-square problem may be in the form shown below in Equation (3):

$${\overline{m}}_{est} = arg m {i}_{\overline{m}} n {‖ {\overline{\overline{W}}}_{d} \cdot ( {\overline{d}}_{obs} - f ( \overline{m} ) ) ‖}_{2}^{2} , \qquad ( 3 )$$

where m̅ is a vector of estimated borehole and formation parameters, d̅_{obs} is the actual measurement channels, f(⋅) is the forward model, and W_{d} is a data-weighting matrix determined by the noise of measurement channels and the accuracy of the forward model.

In certain embodiments, the EM logging tool 58 may include multiple biaxial/triaxial transmitter-receiver (T-R) pairs. These T-R pairs may generate certain measurement channels during logging operations. For example, the measurement channels may be generated by recording the induced voltages at different tool face angles and computing the Fourier fitting coefficients of the voltages with respect to the tool face angles.

These actual measurement channels may be compared to simulated measurement channels constructed through a forward simulation model iteratively to solve for Equation (3). The forward simulation model, for example, may be a three-dimensional (3D) finite element model of the EM tool 58, the borehole 12, and the surrounding formation, wherein the model may be used to compute voltage tensors in the form of Equation (4) below for different T-R pairs:

$$\overline{\overline{V}} = [ \begin{matrix}{V}_{xx} & {V}_{xy} & {V}_{zz} \\ {V}_{yx} & {V}_{yy} & {V}_{yz} \\ {V}_{zx} & {V}_{zy} & {V}_{zz}\end{matrix} ] . \qquad ( 4 )$$

The computed voltage tensors at different T-R spacings may be combined to construct the simulated measurement channels. Thus, the inversion workflow may be configured to find the borehole and formation parameters that may cause the forward simulation model (e.g., 3D finite element model) to produce simulated measurement channels that match the actual measurement channels obtained by the EM tool 58.

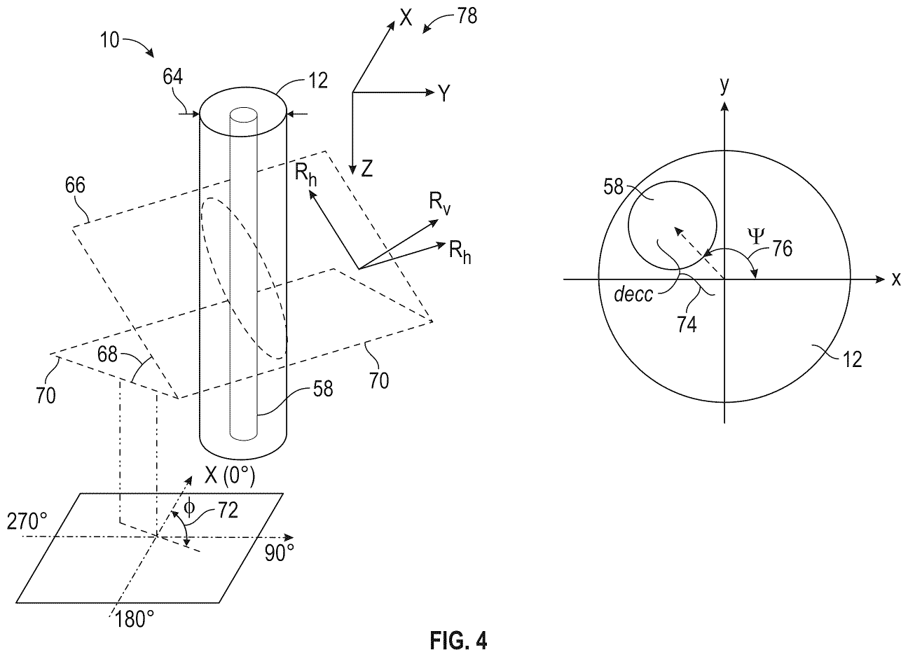

Certain modeling techniques and assumptions employed to simulate the drilling system 10, particularly, the borehole 12, the EM tool 58, and the surrounding formation, are demonstrated below with respect to FIG. 4. Specifically, FIG. 4 includes a set of plots illustrating the relationships amongst the borehole 12, the EM tool 58, and the associated formation in such simulation models.

As illustrated, the EM tool 58 is inserted into the borehole 12 with a borehole diameter (HD) 64. The borehole 12 is filled with drilling mud (e.g., water- or oil-based mud) and/or air and is surrounded by a formation. In the illustrated embodiment, the borehole 12 is assumed to be a circular borehole, and the formation is assumed to be a homogeneous formation with a dipping anisotropy. The drilling mud may have a mud resistivity (R_{mud}).

The borehole 12 may intersect with a formation plane 66. The formation plane 66 may form a formation dip angle (e.g., dip or angle of inclination) 68 with a plane 70 that is perpendicular to the borehole 12 (e.g., horizontal plane). Further, the formation plane 66 may dip in a formation dip azimuth direction (φ) 72. The formation may have a formation horizontal resistivity (Rₕ) and a formation vertical resistivity (Rᵥ), where the formation horizontal resistivity is the resistivity in the direction parallel to the formation plane 66, and the formation vertical resistivity is the resistivity in the direction perpendicular to the formation plane 66. In some embodiments, the formation may be assumed to be a transversely isotropic structure; that is, the formation plane 66 may be assumed to be an isotropic plane.

The EM tool 58 may be eccentric in the borehole 12 with a tool eccentric distance (decc) 74 and a tool eccentric azimuth direction (Ψ) 76. Note that, in the illustrated embodiment, the simulation models use a coordinate system 78 with reference to the borehole 12. However, in certain embodiments, the borehole 12 may deviate from a straight axis, and the simulation models may use the coordinate system 78 with reference to the EM tool 58, where the x-axis and γ-axis of the coordinate system correspond to a x-coil and a y-coil of the EM tool 58, respectively.

In certain embodiments, the borehole and formation parameters may include but may not be limited to: the formation dip angle (dip) 68, the formation dip azimuth (φ) 72, the tool eccentric distance (decc) 74, the tool eccentric azimuth (Ψ) 76, the formation horizontal resistivity (Rₕ), the formation vertical resistivity (Rᵥ), the mud resistivity (R_{mud}), and the borehole diameter (HD) 64. As previously described, these borehole and formation parameters may be estimated by performing an inversion workflow on the downhole EM tool measurements (e.g., solving the nonlinear least-square problem described in Equation (3)). In certain embodiments, the least-square problem such as the one described in Equation (3) may be solved by a nonlinear least-square algorithm, such as the Levenberg-Marquardt algorithm. Beginning with initial guesses of the borehole and formation parameters, the forward simulation model (e.g., 3D finite element model) may run iteratively until certain convergence criteria are met (e.g., the difference between the actual channels and the simulated measurement channels is within a threshold, and/or the number of iterations reaches a maximum limit).

With the borehole and formation parameters, the borehole effect may be quantified. Specifically, the borehole and formation parameters may be used in a simple model, such as a point dipole model, wherein the simple model only accounts for response from the formation to compute measurement channels without borehole effect. The differences between the simulated measurement channels simulated via the full forward simulation model (e.g., 3D finite element model) and the simulated measurement channels simulated via the simple model (e.g., point dipole model) are indicative of the borehole effect in the actual measurement channels obtained from the EM tool 58. Hence, these differences may be subtracted from the actual measurement channels to correct for the borehole effect and obtain the borehole-corrected measurement channels.

However, it should be noted that the borehole correction workflow described above may be challenging in practice, due to the high computational costs associated with computing the measurement channels. Specifically, estimating the borehole and formation parameters may require running the inversion process, which includes running the full forward simulation model (e.g., 3D finite element model), iteratively. The high computational cost makes it difficult to perform real-time interpretation and deploy the algorithm on a downhole computer (e.g., controller of the EM tool 58) with limited resources. Moreover, the inversion depends on the selection of the initial guesses. If the initial guesses of the borehole and formation parameters are far from the true solution, the inversion may be trapped in local minima, resulting in a potentially large error in the estimation of formation properties and tool position.

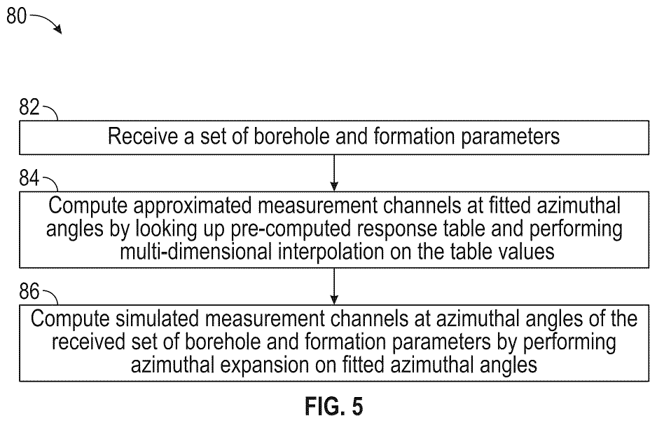

Instead of estimating the borehole and formation parameters via the full forward simulation model (e.g., 3D finite element model), the presently disclosed techniques utilize a surrogate model of the full forward simulation model to reduce the computational cost of forward modeling. FIG. 5 is a flowchart of an embodiment of a method 80 of computing simulated measurement channels using the surrogate model. It should be noted that the steps of the method 80 illustrated in FIG. 5 and described in detail below are exemplary and should not be taken to necessarily imply a chronological order of the method 80. While the steps of the method 80 may be performed in the order illustrated in FIG. 5, presently disclosed embodiments include any suitable ordering and/or chronology of these steps. Further, certain embodiments of the method 80 may include steps other than those illustrated in FIG. 5. In certain embodiments, the method 80 may be executed on the controller 48 of the logging tool 32 (e.g., EM tool 58), the controller 39 of the data processing system 38, or any combination thereof. Further still, certain steps of the method 80 illustrated in FIG. 5 may be omitted and/or altered in other embodiments.

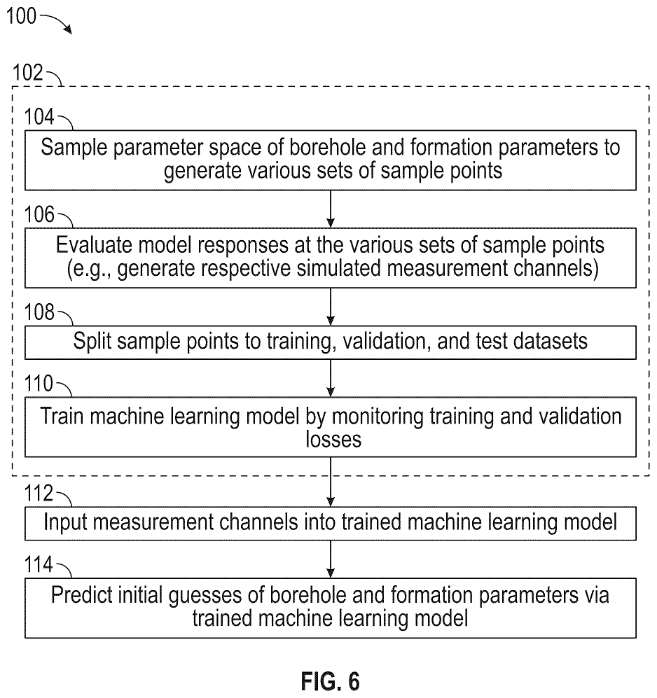

The method 80 may include receiving (block 82) a set of borehole and formation parameters. For example, the method 80 may include receiving a set of initial guesses of the borehole and formation parameters obtained via a machine learning model, wherein the set of initial guesses of the borehole and formation parameters is obtained according to the method described in further detail below with respect to FIG. 6. As previously discussed, the borehole and formation parameters may include but may not be limited to: the formation dip angle (dip) 68, the formation dip azimuth (φ) 72, the tool eccentric distance (decc) 74, the tool eccentric azimuth (Ψ) 76, the formation horizontal resistivity (Rₕ), the formation vertical resistivity (Rᵥ), the mud resistivity (R_{mud}), and the borehole diameter (HD).

In utilizing the surrogate model, a comprehensive library (e.g., look-up table) including pre-computed forward modeling responses at selected combinations of the borehole and formation parameters is utilized. For example, the library may include a wide range of possible combinations of borehole and formation parameters and the corresponding responses at a few azimuthal angles. In certain embodiments, the parameter ranges may be determined by actual tool configurations, drilling conditions, and geology. Within the parameter ranges, an n-dimensional grid may be created by uniformly sampling across specified ranges in each dimension. For example, the library may include combinations of independent borehole and formation parameters at values selected by field experts. Thus, the surrogate model may use multi-dimensional interpolation between sample points, substantially reducing the computational cost compared to running the full model.

In certain embodiments, cloud-based clusters may be utilized to create the library efficiently. Specifically, a cloud-computing workflow that runs the full forward simulation model in parallel may be used to populate the library. In such workflow, the design cases indicative of various combinations of independent borehole and formation parameters may be split into different job batches. Then, each job batch is sent to a job scheduler, such as Simple Linux Utility for Resource Management (SLURM). The job scheduler will assign the simulation job to the computing nodes based on available resources. During the simulation, the results will be synchronized back to a local machine (e.g., computing system) once the simulation is completed. In certain embodiments, a subset of all the design cases may be randomly selected and executed on a local machine to validate the simulation results.

To further optimize memory usage, the library may be divided into smaller sub-libraries based on initial parameter values. This approach may allow only the relevant portion of the library to be loaded into random access memory (RAM), thus reducing memory requirements. This technique is particularly beneficial for implementation in a downhole computing system (e.g., controller 48 of the logging tool 32, EM tool 58), where computational resources are limited.

It should be noted that, in certain embodiments, the library may only record the forward modeling responses at a few selected azimuthal angles. For example, the library may include various combinations of the formation dip angle (dip) 68, the formation dip azimuth (φ) 72, the tool eccentric distance (decc) 74, the tool eccentric azimuth (Ψ) 76, the formation horizontal resistivity (Rₕ), the formation vertical resistivity (Rᵥ), the mud resistivity (R_{mud}), and the borehole diameter (HD) 64; however, the sampling points of the formation dip azimuth (φ) 72 and the tool eccentric azimuth (Ψ) 76 within their respective parameter ranges may be limited. In certain embodiments, only three distinct combinations of the formation dip azimuth (φ) 72 and the tool eccentric azimuth (Ψ) 76 are included in the library. However, in some embodiments, the library may include other numbers of distinct combinations. By limiting the amount of azimuthal sampling points, the computational time to construct the library may be further reduced. In such embodiments, an azimuthal expansion method is applied to calculate azimuthal responses at any azimuthal angle combination. That is, the interpolation of the formation dip angle (dip) 68, the tool eccentric distance (decc) 74, the formation horizontal resistivity (Rₕ), the formation vertical resistivity (Rᵥ), the mud resistivity (R_{mud}), and the borehole diameter (HD) 64 is performed in a six-dimensional (6D) space using the library, while the dependence of the formation dip azimuth (φ) 72 and the tool eccentric azimuth (Ψ) 76 is characterized using the selected distinct combinations of azimuthal angles.

In certain embodiments, azimuthal expansion assumes that the voltage tensor may be expanded as a 2-dimensional Fourier series up to the order of 5 using Equation (5):

$${V}_{ij} \approx {\sum }_{n = 0}^{5} {\sum }_{m = 0}^{5 - n} {A}_{nm} cos ( n ϕ ) cos ( m Ψ ) + {B}_{nm} sin ( n ϕ ) cos ( m Ψ ) + {C}_{nm} cos ( n ϕ ) sin ( m Ψ ) + {D}_{nm} sin ( n ϕ ) sin ( m Ψ ) \qquad ( 5 )$$

where Aₙₘ, Bₙₘ, Cₙₘ, and Dₙₘ are fitting coefficients and may be estimated by fitting a few azimuthal points. In some embodiments, some of the terms in Equation (5) may be neglected or correlated. Therefore, the fitting coefficients may be combined and solved more robustly with azimuthal points.

In certain embodiments, the fitting terms in Equation (5) may be obtained through a workflow as described below to balance the accuracy and robustness of the fit. First, several cases with different formation conductivities are designed. Then, certain uniform sampling points for the formation dip azimuth (φ) 72 and the tool eccentric azimuth (Ψ) 76 are selected, such that enough number of sampling points are selected for solving all the fitting terms in Equation (5). For example, the formation dip azimuth (φ) 72 and the tool eccentric azimuth (Ψ) may be sampled every 30°. Finally, Lasso regression with a certain pre-determined accuracy criterion is used to obtain a subset of the fitting terms from Equation (5). Fitting coefficients with negligible effects are set as 0, and correlated coefficients are combined based on a threshold of the fitting. This fitting workflow can be applied to 1) voltage couplings directly, or 2) quantities derived from voltage couplings such as combinations of voltage couplings with some calibration/normalization terms.

For example, in certain embodiments, it may be found that three specific combinations of azimuthal angles may give good fitting results of Equation (5) for all coupling voltages. Thus, the method 80 may also include computing (block 84) approximated measurement channels at the fitted combinations of azimuthal angles by looking up the pre-computed table and performing a multi-dimensional interpolation of the other borehole and formation parameters (e.g., 6D interpolation of the formation dip angle (dip) 68, the tool eccentric distance (decc) 74, the formation horizontal resistivity (Rₕ), the formation vertical resistivity (Rᵥ), the mud resistivity (R_{mud}), and the borehole diameter (HD) 64) on the table values. Note that these approximated measurement channels are evaluated at the fitted combinations of azimuthal angles; thus, the method 80 may further include computing (block 86) simulated measurement channels at azimuthal angles of the received set of borehole and formation parameters by performing azimuthal expansion on the limited fitted combinations of azimuthal angles, where the azimuthal expansion algorithm may expand the approximated measurement channels evaluated at the limited fitted combinations of azimuthal angles to simulated measurement channels at any given azimuthal angles.

Furthermore, for some measurements, the first-order terms cos (Ψ), sin (Ψ), cos (φ), and sin (φ) may dominate directional measurements V_{xz}−V_{zx}, V_{yz}−V_{zy}, V_{xz}+V_{zx}, and V_{yz}+V_{zy}, respectively. The fitting coefficients depend on the spacing, frequency, and real/imaginary part. These first-order terms imply that azimuthal angles can be directly estimated using a subset of the measurement channels using Equations (6) and (7) below:

$${ϕ}_{est} = Mod ( a tan 2 ( {V}_{yz} + {V}_{zy} , {V}_{xz} + {V}_{zx} ) \cdot \frac{180}{π} , 360 ) , \qquad ( 6 )$$

$${Ψ}_{est} = Mod ( a tan 2 ( {V}_{yz} - {V}_{zy} , {V}_{xz} - {V}_{zx} ) \cdot \frac{180}{π} , 360 ) . \qquad ( 7 )$$

Moreover, if measurements are available for multiple frequencies and spacings, an averaged (V_{xz}+V_{zx})/(V_{xz}−V_{zx}) and (V_{yz}+V_{zy})/(V_{xz}−V_{zx}) can be used in Equations (6) and (7) to improve the accuracy and robustness in the presence of noise. For example, the medians or means of certain measurement channels may be used for estimating φ and Ψ using Equations (8)-(11) below, respectively:

$$\overline{{V}_{xz} + {V}_{zx}} = median ( \{ {( {V}_{xz} + {V}_{zx} )}_{ijk} \} ) , \qquad ( 8 )$$

$$\overline{{V}_{yz} + {V}_{zy}} = median ( \{ {( {V}_{yz} + {V}_{zy} )}_{ijk} \} ) , \qquad ( 9 )$$

$$\overline{{V}_{xz} - {V}_{zx}} = mean ( \{ {( {V}_{xz} - {V}_{zx} )}_{ijk} \} ) , \qquad ( 10 )$$

$$\overline{{V}_{yz} - {V}_{zy}} = mean ( \{ {( {V}_{yz} - {V}_{zy} )}_{ijk} \} ) , \qquad ( 11 )$$

where the indices i, j, and k represent different T-R spacings, frequencies, and real/imaginary parts. Thus, in some embodiments, the presently disclosed inversion workflow may use the azimuthal equations above, Equations (6)-(11), to calculate certain borehole and formation parameters (e.g., the formation dip azimuth (φ) 72 and the tool eccentric azimuth (Ψ) 76) directly from the measurement channels. By doing so, the computational costs may be further reduced as less borehole and formation parameters may need to be estimated through the iterative inversion workflow (that is, the iterative inversion workflow may only need to solve a 6D nonlinear least-square problem instead of an eight-dimensional (8D) nonlinear least-square problem).

Further, the presently disclosed inversion workflow may use machine learning models to generate initial guesses for the inversion to further reduce the computation cost associated with the inversion workflow. As previously discussed, the borehole correction inversion is an optimization workflow that starts with an initial guess of borehole and formation parameters and updates them iteratively. A good initial guess is advantageous to ensure rapid convergence of the algorithm without being trapped in local minima. For example, a machine learning model, such as one based on a neural network structure with multiple fully connected layers, may be used to estimate certain borehole and formation parameters. In certain embodiments, the initial guesses of some borehole and formation parameters may be determined through the machine learning model, whereas initial guesses of some other borehole and formation parameters may not necessarily be determined the machine learning model. This is because the machine learning model may provide generally better quality initial guesses for some borehole and formation parameters but not necessarily the others. For example, in certain embodiments, a method of determining initial guesses may include determining the initial guesses of the formation dip angle (dip) 68, the formation horizontal resistivity (Rₕ), the formation vertical resistivity (Rᵥ), and the mud resistivity (R_{mud}) through the machine learning model, while refraining from determining the initial guesses of the tool eccentric distance (decc) 74 and the borehole diameter (HD) 64 through the machine learning model.

FIG. 6 is a flow chart of an embodiment of a method 100 to predict initial guesses of certain borehole and formation parameters. It should be noted that the steps of the method 100 illustrated in FIG. 6 and described in detail below are exemplary and should not be taken to necessarily imply a chronological order of the method 100. While the steps of the method 100 may be performed in the order illustrated in FIG. 6, presently disclosed embodiments include any suitable ordering and/or chronology of these steps. Further, certain embodiments of the method 100 may include steps other than those illustrated in FIG. 6. In certain embodiments, the method 100 may be executed on the controller 48 of the logging tool 32 (e.g., EM tool 58), the controller 39 of the data processing system 38, or any combination thereof. Further still, certain steps of the method 100 illustrated in FIG. 6 may be omitted and/or altered in other embodiments.

The method 100 may include training (block 102) a machine learning model (e.g., machine learning inversion model) for a machine learning-assisted inversion of measurement data from the logging tool 32 (e.g., EM tool 58). Specifically, training the machine learning model may include sampling (block 104) a parameter space of borehole and formation parameters to generate various sets of sample points. For example, the full 8D space of the formation dip angle (dip) 68, the formation dip azimuth (φ) 72, the tool eccentric distance (decc) 74, the tool eccentric azimuth (Ψ) 76, the formation horizontal resistivity (Rₕ), the formation vertical resistivity (Rᵥ), the mud resistivity (R_{mud}), and the borehole diameter (HD) 64 may be sampled uniformly. In certain embodiments, Latin Hypercube Sampling (LHS) may be utilized to cover the eight-dimensional parameter space uniformly and efficiently.

Training the machine learning model may also include evaluating (block 106) model responses (e.g., generating respective simulated measurement channels) at the various sets of sample points. In certain embodiments, the responses are evaluated by running the full forward simulation model (e.g., 3D finite element model) at individual sample points.

Training the machine learning model may further include splitting (block 108) the sampling points to training, validation, and test datasets and training (block 110) the machine learning model by monitoring training and validation losses. In certain embodiments, the training process continues until good convergences of the training and validation losses are achieved.

After the machine learning model is trained, the method 100 may include inputting (block 112) measurement channels obtained from the EM tool 58 into the trained machine learning model (e.g., machine learning inversion model). The method may, subsequently, include predicting (block 114) initial guesses of borehole and formation parameters via the trained machine learning model. Note that, as previously discussed, in some embodiments, only initial guesses of certain, but not all, parameters (e.g., the formation dip angle (dip) 68, the formation horizontal resistivity (Rₕ), the formation vertical resistivity (Rᵥ), and the mud resistivity (R_{mud})) may be retained as initial inputs of the iterative inversion workflow.

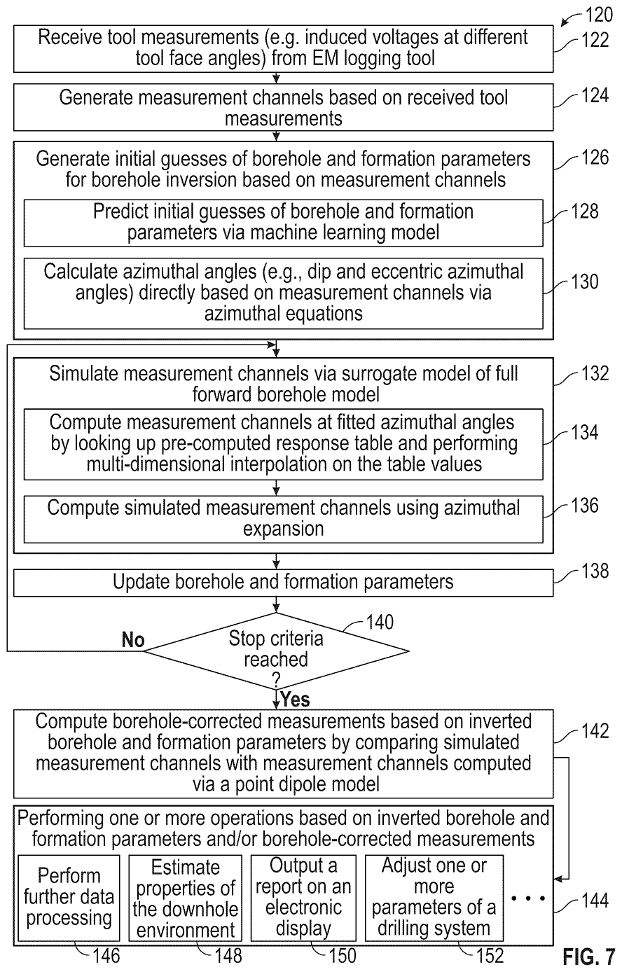

FIG. 7 is a flowchart of an embodiment of a method 120 of performing operations associated with the wellsite system of FIG. 1 based on inverted borehole and formation parameters and/or borehole-corrected measurements. It should be noted that the steps of the method 120 illustrated in FIG. 7 and described in detail below are exemplary and should not be taken to necessarily imply a chronological order of the method 120. While the steps of the method 120 may be performed in the order illustrated in FIG. 7, presently disclosed embodiments include any suitable ordering and/or chronology of these steps. Further, certain embodiments of the method 120 may include steps other than those illustrated in FIG. 7. In certain embodiments, the method 120 may be executed on the controller 48 of the logging tool 32 (e.g., EM tool 58), the controller 39 of the data processing system 38, or any combination thereof. Further still, certain steps of the method 120 illustrated in FIG. 7 may be omitted and/or altered in other embodiments.

The method 120 may include receiving (block 122) tool measurements (e.g., induced voltages at different tool face angles) from the EM logging tool 58. In some embodiments, the method 120 may also generate (block 124) specific measurement channels (e.g., voltage tensors with various voltage couplings) based on the received tool measurements.

The method 120 may include generating (block 126) initial guesses of the borehole and formation parameters for the borehole inversion workflow based on the measurement channels. As previously discussed, the general goal of the borehole inversion workflow is to estimate borehole and formation parameters that may cause a forward simulation model (e.g., 3D finite element model) to produce simulated measurement channels that match the actual measurement channels obtained by the EM tool 58. the borehole and formation parameters may include but may not be limited to: the formation dip angle (dip) 68, the formation dip azimuth (φ) 72, the tool eccentric distance (decc) 74, the tool eccentric azimuth (Ψ) 76, the formation horizontal resistivity (Rₕ), the formation vertical resistivity (Rᵥ), the mud resistivity (R_{mud}), and the borehole diameter (HD) 64. Specifically, the generating initial guesses of block 126 may include predicting (block 128) initial guesses of certain borehole and formation parameters (e.g., the formation dip angle (dip) 68, the formation horizontal resistivity (Rₕ), the formation vertical resistivity (Rᵥ), and the mud resistivity (R_{mud})) via a trained machine learning model (e.g., machine learning inversion model) and calculate azimuthal angles (e.g., the formation dip azimuth (φ) 72 and the tool eccentric azimuth (Ψ) 76) directly from the measurement channels via azimuthal equations (e.g., Equations (6)-(11)).

The method 120 may include simulating (block 132) measurement channels via a surrogate model of a full forward borehole simulation model (e.g., 3D finite element model). Specifically, the calculation of the simulated measurement channels may include computing (block 134) measurement channels at fitted azimuthal angles by looking up a pre-computed response table and performing multi-dimensional interpolation (e.g., 6D interpolation of the formation dip angle (dip) 68, the tool eccentric distance (decc) 74, the formation horizontal resistivity (Rₕ), the formation vertical resistivity (Rᵥ), the mud resistivity (R_{mud}), and the borehole diameter (HD) 64) on the table values. The calculation may also include computing (block 136) simulated measurement channels at the calculated azimuthal angles (e.g., the formation dip azimuth (φ) 72 and the tool eccentric azimuth (Ψ) 76) by performing azimuthal expansion on the limited fitted combinations of azimuthal angles.

The method 120 may include updating (block 138) the borehole and formation parameters. For example, a nonlinear least-square algorithm, such as the Levenberg-Marquardt algorithm, may be used to generate next guesses of the borehole and formation parameters. The method 120 may include determining (block 140) whether stop criteria of the iterative inversion workflow are reached. For example, the method 120 may update the parameters based on the difference (e.g., mismatch) between simulated and actual measurements until such difference is small enough or the maximum number of iterations is reached. As a specific example, the method 120 may include comparing the first simulated measurement data and the measurement data to obtain a data comparison (e.g., quantify a mismatch), updating the initial guesses for the borehole and formation parameters based on the comparison (e.g., mismatch), and performing the simulating, the comparing, and the updating iteratively until stop criteria are reached. If the stop criteria are not reached, the method 120 may return to block 132 to continue simulating measurement channels corresponding to the updated borehole and formation parameters via the surrogate model.

Conversely, if the stop criteria are reached, the method 120 may proceed to compute (block 142) borehole corrected measurements based on inverted borehole and formation parameters (e.g., latest set of borehole and formation parameters) by comparing simulated measurement channels with measurement channels computed via a point dipole model. That is, the simulated measurement channels from two models are compared against each other: 1) the full forward simulation model taking into account both borehole and formation (e.g., 3D finite element model), and 2) a simplified point dipole model that only considers the contribution from the formation. The difference between these two models may be subtracted from the actual measurement channels obtained from the EM tool 58 to mitigate the borehole effects.

The method 120 may include performing (block 144) one or more operations based on the inverted borehole and formation parameters and/or the borehole-corrected measurements. For example, the method 120 may include performing further data processing (block 146). The further data processing may include other usages of the borehole correction results (e.g., not drilling-related and/or post-drilling), such as formation evaluation (e.g., calculating the reserve), completion (e.g., e-caliper), geological applications using dip which is the direct measurement of structural dip in shales, or any combination thereof. Thus, the further data processing may include any one or more types of data processing associated with the geological formation, the borehole, the hydrocarbons in the geological formation, drilling parameters, post-drilling parameters, and various aspects impacting production. As another example, the method 120 may include estimating (block 148) properties of the downhole environment, such as lithology, porosity, fluid content, and saturation, based on the inverted borehole and formation parameters and/or the borehole-corrected measurements. As a further example, the method 120 may include outputting (block 150) a report on an electronic display, which, by way of example, may be a graphical user interface (GUI) of an electronic display (e.g., display 46 of the data processing system 38) of the drilling system 10 during drilling operation. The report may include the inverted borehole and formation parameters, the borehole-corrected measurements, the estimated properties of the downhole environment, or any combination thereof. As another more specific example, improved inversion and imaging results based on the corrected measurements may be generated and displayed on the electronic display to provide more accurate imaging of the wellsite subsurface environment. The outputs can be generated in real-time and used for detecting borehole size changes (like an e-caliper), such as washout zones, unconsolidated formations, evaluating formation resistivity, estimating hydrocarbon in place, improving the quality of geosteering and reservoir mapping inversion, and ultimately helping real-time decision-making and control changes during drilling operations. Additionally or alternatively, the method 120 may include adjusting (block 152) one or more parameters of the drilling system 10 based on the inverted borehole and formation parameters and/or the borehole-corrected measurements. As a more specific example, with the more accurate measurements and the improved inversion and imaging results, the drilling system 10 may adjust a drilling direction (e.g., via adjustments to the RSS), a rotational speed of the drill bit, a flow rate of drilling mud, a weight on bit, a torque on bit, a mud weight, a mud viscosity, a rate of penetration, or any combination thereof, based on the improved imaging to provide higher quality drilling to desired locations within a geological formation. As another more specific example, during drilling operations, based on the inverted parameters such as borehole diameter 64, the drilling system 10 may detect subsurface risk factors such as washout and mudcake buildup and mitigate the risk factors. As a further more specific example, since a washout may cause issues like stuck pipes and increase torque and drag, the drilling system 10 may reduce the drilling speed in response to detecting a washout.

Technical effects of the disclosed embodiments enable a machine learning-assisted inversion workflow using a machine learning model (e.g., machine learning inversion model) to improve the inversion of measurements from logging tools 32 (e.g., EM tools 58). The machine learning model may be trained using measurements in areas of a geological formation, and the trained model may be subsequently used to perform the inversion of measurements in real-time during drilling operations. The machine learning model may provide guesses or predictions of various borehole and formation parameters during the inversion process, thereby reducing computational resources, reducing time for computations, and enabling faster (e.g., real-time) inversions of the measurements. As a result, the machine learning model disclosed herein may be performed downhole via the controller 48 of the logging tool 32 (e.g., EM tool 58), remotely via the data processing system 38, or any combination thereof, such that the drilling system 10 can be controlled in real-time based on the inversion of the measurements. For example, the control of the drilling system 10 based on the foregoing inversion techniques may include adjusting a direction of drilling via the RSS, adjusting a rotational speed of a drill bit, adjusting a flow rate of drilling mud, a weight on bit, a torque on bit, a mud weight, a mud viscosity, a rate of penetration, or any combination thereof.

The subject matter described in detail above may be defined by one or more clauses, as set forth below.

A method includes receiving measurement data from a downhole tool in a borehole in a geological formation. The method further includes performing a borehole correction inversion of the measurement data assisted by a machine learning model to obtain one or more properties. Performing the borehole correction inversion includes building a borehole table for a plurality of muds using an expansion for a tool response in an azimuthal direction of the machine learning model. Performing the borehole correction inversion further includes obtaining initial guesses for borehole and formation parameters of the borehole correction inversion at least partially via the machine learning model. Performing the borehole correction inversion uses at least partially the initial guesses in the plurality of muds to determine the borehole and formation parameters. The method further includes adjusting one or more operating parameters based on the one or more properties or the borehole correction inversion of the measurement data, wherein the one or more operating parameters include drilling parameters, post-drilling parameters, or a combination thereof.

The method of the preceding clause, wherein the initial guesses for the borehole and formation parameters include a formation dip angle, a formation dip azimuth, a tool eccentric azimuth, a formation horizontal resistivity, a formation vertical resistivity, a mud resistivity, a tool eccentric distance, a borehole diameter, or any combination thereof.

The method of any preceding clause, wherein the initial guesses for the borehole and formation parameters include a formation dip angle, a formation horizontal resistivity, a formation vertical resistivity, and a mud resistivity.

The method of any preceding clause, wherein obtaining the initial guesses for the borehole and formation parameters includes predicting at least a first portion of the initial guesses for the borehole and formation parameters via the machine learning model, wherein the first portion of the borehole and formation parameters includes a formation dip angle, a formation horizontal resistivity, a formation vertical resistivity, and a mud resistivity.

The method of any preceding clause, wherein obtaining the initial guesses for the borehole and formation parameters includes calculating at least a second portion of the borehole and formation parameters based on the measurement data.

The method of any preceding clause, wherein the second portion includes a formation dip azimuth and a tool eccentric azimuth.

The method of any preceding clause, wherein performing the borehole correction inversion includes simulating measurement data based on a first model to obtain first simulated measurement data based on the initial guesses for borehole and formation parameters, comparing the first simulated measurement data and the measurement data to quantify a mismatch, updating the borehole and formation parameters based on the mismatch, and performing the simulating, the comparing, and the updating iteratively until reaching a stop criteria to obtain inverted borehole and formation parameters.

The method of any preceding clause, wherein simulating the measurement data based on the first model includes searching a table of a plurality of combinations of the borehole and formation parameters to obtain table values, and interpolating the table values to obtain the first simulated measurement data.

The method of any preceding clause, wherein simulating the measurement data based on the first model includes performing an azimuthal expansion to calculate azimuthal responses at different azimuthal angle combinations.

The method of any preceding clause, wherein performing the borehole correction inversion includes simulating measurement data based on a second model to obtain second simulated measurement data, wherein the first model includes borehole effects and the second model excludes the borehole effects, calculating a difference between the first and second simulated measurement data indicative of the borehole effects, and removing the difference from the measurement data to correct for the borehole effects.

The method of any preceding clause, wherein the machine learning model is trained via a plurality of iterations of sampling a parameter space of the borehole and formation parameters to generate sets of sample points, evaluating model responses at the sets of sample points, splitting sample points to training, validation, and test datasets, and training the machine learning model by monitoring training and validation losses.

The method of any preceding clause, wherein the one or more properties include borehole-corrected measurement data.

The method of any preceding clause, wherein the one or more properties include a density, a porosity, a permeability, a resistivity, a lithology, a fluid content, a saturation, or any combination thereof.

The method of any preceding clause, wherein receiving the measurement data, performing the borehole correction inversion, and adjusting the one or more operating parameters are performed in real-time, wherein the one or more operating parameters include the drilling parameters. The drilling parameters include a direction of drilling, a rotational speed of a drill bit, a flow rate of a drilling mud, a weight on bit, a torque on bit, a mud weight, a mud viscosity, a rate of penetration, or a combination thereof.

A system includes a processor and a memory including instructions executable by the processor, wherein the instructions are configured to perform operations including receiving measurement data from a downhole tool in a borehole in a geological formation. The operations further include performing a borehole correction inversion of the measurement data assisted by a machine learning model to obtain one or more properties, wherein performing the borehole correction inversion includes obtaining initial guesses for borehole and formation parameters of the borehole correction inversion at least partially via the machine learning model.

The system of the preceding clause, wherein the instructions are configured to perform operations including: building a borehole table for a plurality of muds using an expansion for a tool response in an azimuthal direction of the machine learning model, performing the borehole correction inversion using at least partially the initial guesses in the plurality of muds to determine the borehole and formation parameters, and adjusting one or more operating parameters based on the one or more properties or the borehole correction inversion of the measurement data, wherein the one or more operating parameters include drilling parameters, post-drilling parameters, or a combination thereof.

The system of any preceding clause, wherein the instructions are configured to perform operations including obtaining the initial guesses for the borehole and formation parameters, wherein the operations include predicting at least a first portion of the borehole and formation parameters via the machine learning mode, and calculating at least a second portion of the borehole and formation parameters based on the measurement data. The borehole and formation parameters include a formation dip angle, a formation dip azimuth, a tool eccentric azimuth, a formation horizontal resistivity, a formation vertical resistivity, a mud resistivity, a tool eccentric distance, a borehole diameter, or any combination thereof.

A tangible and non-transitory machine readable medium including instructions configured to perform operations including receiving measurement data from a downhole tool in a borehole in a geological formation. The operations further include performing a borehole correction inversion of the measurement data assisted by a machine learning model to obtain one or more properties, wherein performing the borehole correction inversion includes obtaining initial guesses for borehole and formation parameters of the borehole correction inversion at least partially via the machine learning model.

The medium of the preceding clause, wherein the instructions are configured to perform operations including: building a borehole table for a plurality of muds using an expansion for a tool response in an azimuthal direction of the machine learning model, performing the borehole correction inversion using at least partially the initial guesses in the plurality of muds to determine the borehole and formation parameters, and adjusting one or more operating parameters based on the one or more properties or the borehole correction inversion of the measurement data, wherein the one or more operating parameters include drilling parameters, post-drilling parameters, or a combination thereof.

The medium of any preceding clause, wherein the instructions configured to perform operations including obtaining the initial guesses for the borehole and formation parameters, wherein the operations include predicting at least a first portion of the borehole and formation parameters via the machine learning mode, and calculating at least a second portion of the borehole and formation parameters based on the measurement data. The borehole and formation parameters include a formation dip angle, a formation dip azimuth, a tool eccentric azimuth, a formation horizontal resistivity, a formation vertical resistivity, a mud resistivity, a tool eccentric distance, a borehole diameter, or any combination thereof.

While only certain features of the disclosure have been illustrated and described herein, many modifications and changes will occur to those skilled in the art. It is, therefore, to be understood that the appended claims are intended to cover all such modifications and changes as fall within the true spirit of the disclosure. It should be appreciated that any features shown and described with reference to the foregoing figures may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112 (f). However, for any claims containing elements designated in any other manner, it is intended that such elements are not to be interpreted under 35 U.S.C. 112(f).

What is claimed is:

1. A method, comprising:
receiving measurement data from a downhole tool in a borehole in a geological formation; and
performing a borehole correction inversion of the measurement data assisted by a machine learning model to obtain one or more properties, wherein performing the borehole correction inversion comprises:
building a borehole table for a plurality of muds using an expansion for a tool response in an azimuthal direction of the machine learning model;
obtaining initial guesses for borehole and formation parameters of the borehole correction inversion at least partially via the machine learning model; and
performing the borehole correction inversion using at least partially the initial guesses in the plurality of muds to determine the borehole and formation parameters; and
adjusting one or more operating parameters based on the one or more properties or the borehole correction inversion of the measurement data, wherein the one or more operating parameters comprise drilling parameters, post-drilling parameters, or a combination thereof.

2. The method of claim 1, wherein the initial guesses for the borehole and formation parameters comprise a formation dip angle, a formation dip azimuth, a tool eccentric azimuth, a formation horizontal resistivity, a formation vertical resistivity, a mud resistivity, a tool eccentric distance, a borehole diameter, or any combination thereof.

3. The method of claim 1, wherein the initial guesses for the borehole and formation parameters comprise a formation dip angle, a formation horizontal resistivity, a formation vertical resistivity, and a mud resistivity.

4. The method of claim 1, wherein obtaining the initial guesses for the borehole and formation parameters comprises:
predicting at least a first portion of the initial guesses for the borehole and formation parameters via the machine learning model, wherein the first portion of the borehole and formation parameters comprises a formation dip angle, a formation horizontal resistivity, a formation vertical resistivity, and a mud resistivity.

5. The method of claim 4, wherein obtaining the initial guesses for the borehole and formation parameters comprises:
calculating at least a second portion of the borehole and formation parameters based on the measurement data.

6. The method of claim 5, wherein the second portion comprises a formation dip azimuth and a tool eccentric azimuth.

7. The method of claim 1, wherein performing the borehole correction inversion comprises:
simulating measurement data based on a first model to obtain first simulated measurement data based on the initial guesses for the borehole and formation parameters;
comparing the first simulated measurement data and the measurement data to quantify a mismatch;
updating the borehole and formation parameters based on the mismatch; and
performing the simulating, the comparing, and the updating iteratively until reaching stop criteria to obtain inverted borehole and formation parameters.

8. The method of claim 7, wherein simulating the measurement data based on the first model comprises:
searching a table of a plurality of combinations of the borehole and formation parameters to obtain table values; and
interpolating the table values to obtain the first simulated measurement data.

9. The method of claim 8, wherein simulating the measurement data based on the first model comprises performing an azimuthal expansion to calculate azimuthal responses at different azimuthal angle combinations.

10. The method of claim 7, wherein performing the borehole correction inversion comprises:
simulating measurement data based on a second model to obtain second simulated measurement data, wherein the first model includes borehole effects and the second model excludes the borehole effects;
calculating a difference between the first and second simulated measurement data indicative of the borehole effects; and
removing the difference from the measurement data to correct for the borehole effects.

11. The method of claim 1, wherein the machine learning model is trained via a plurality of iterations of:
sampling a parameter space of the borehole and formation parameters to generate sets of sample points;
evaluating model responses at the sets of sample points;
splitting sample points to training, validation, and test datasets; and
training the machine learning model by monitoring training and validation losses.

12. The method of claim 1, wherein the one or more properties comprise borehole-corrected measurement data.

13. The method of claim 12, wherein the one or more properties comprise a density, a porosity, a permeability, a resistivity, a lithology, a fluid content, a saturation, or any combination thereof.

14. The method of claim 1, wherein receiving the measurement data, performing the borehole correction inversion, and adjusting the one or more operating parameters are performed in real-time, wherein the one or more operating parameters comprise the drilling parameters including a direction of drilling, a rotational speed of a drill bit, a flow rate of a drilling mud, a weight on bit, a torque on bit, a mud weight, a mud viscosity, a rate of penetration, or a combination thereof.

15. A system, comprising:
a processor; and
a memory comprising instructions executable by the processor, wherein the instructions are configured to perform operations comprising:
receiving measurement data from a downhole tool in a borehole in a geological formation; and
performing a borehole correction inversion of the measurement data assisted by a machine learning model to obtain one or more properties, wherein performing the borehole correction inversion comprises:
obtaining initial guesses for borehole and formation parameters of the borehole correction inversion at least partially via the machine learning model.

16. The system of claim 15, wherein the instructions are configured to perform operations comprising:
building a borehole table for a plurality of muds using an expansion for a tool response in an azimuthal direction of the machine learning model;
performing the borehole correction inversion using at least partially the initial guesses in the plurality of muds to determine the borehole and formation parameters; and
adjusting one or more operating parameters based on the one or more properties or the borehole correction inversion of the measurement data, wherein the one or more operating parameters comprise drilling parameters, post-drilling parameters, or a combination thereof.

17. The system of claim 15, wherein the instructions are configured to perform operations comprising obtaining the initial guesses for the borehole and formation parameters, comprising:
predicting at least a first portion of the borehole and formation parameters via the machine learning model; and
calculating at least a second portion of the borehole and formation parameters based on the measurement data,
wherein the borehole and formation parameters comprise a formation dip angle, a formation dip azimuth, a tool eccentric azimuth, a formation horizontal resistivity, a formation vertical resistivity, a mud resistivity, a tool eccentric distance, a borehole diameter, or any combination thereof.

18. A tangible and non-transitory machine readable medium comprising instructions configured to perform operations comprising:
receiving measurement data from a downhole tool in a borehole in a geological formation; and
performing a borehole correction inversion of the measurement data assisted by a machine learning model to obtain one or more properties, wherein performing the borehole correction inversion comprises:
obtaining initial guesses for borehole and formation parameters of the borehole correction inversion at least partially via the machine learning model.

19. The medium of claim 18, wherein the instructions are configured to perform operations comprising:
building a borehole table for a plurality of muds using an expansion for a tool response in an azimuthal direction of the machine learning model;
performing the borehole correction inversion using at least partially the initial guesses in the plurality of muds to determine the borehole and formation parameters; and
adjusting one or more operating parameters based on the one or more properties or the borehole correction inversion of the measurement data, wherein the one or more operating parameters comprise drilling parameters, post-drilling parameters, or a combination thereof.

20. The medium of claim 18, wherein the instructions configured to perform operations comprising obtaining the initial guesses for the borehole and formation parameters, comprise:
predicting at least a first portion of the borehole and formation parameters via the machine learning model; and
calculating at least a second portion of the borehole and formation parameters based on the measurement data,
wherein the borehole and formation parameters comprise a formation dip angle, a formation dip azimuth, a tool eccentric azimuth, a formation horizontal resistivity, a formation vertical resistivity, a mud resistivity, a tool eccentric distance, a borehole diameter, or any combination thereof.
